(19) United States
(12) Patent Application Publication
(10) Pub. No.: US 2019/0313131 A1
(43) Pub. Date: Oct. 10, 2019

(54) APPARATUSES, NETWORKS, SYSTEMS, AND METHODS FOR REAL-TIME MONITORING OF REMOTE EVENTS

(71) Applicant: Brant A. Ring, Fort Worth, TX (US)

(72) Inventor: Brant A. Ring, Fort Worth, TX (US)

(21) Appl. No.: 15/946,356

(22) Filed: Apr. 5, 2018

(51) Int. Cl. H04N 21/2187; H04L 29/06; H04N 7/18; H04N 5/232; H04N 21/61; H04N 21/414; H04N 21/218

(52) U.S. Cl. CPC H04N 21/2187; H04L 65/4069; H04N 7/181; H04N 21/21805; H04N 21/6181; H04N 21/41407; H04N 5/23296

(57) ABSTRACT

Apparatuses, networks, systems, and/or methods for permitting remote virtual attendance at an event are provided that include a network interface capable of communicating with the Internet, at least one transceiver capable of communicating with the network interface, and multiple cameras capable of communicating with the transceiver. The cameras are located in or around a field of play. An object detection system that is capable of directing the cameras where to point or object. The object detection system may direct the cameras to point to, and stream or record, the video image of a particular player who has been identified and tracked. The cameras may transmit real-time video of a tracked object to the transceiver. After being routed to the network interface, the network interface transmits the video of a tracked individual over the Internet for receipt by one or more particular remote devices, such as smart phones.

### BACKGROUND

There is a growing need for remote attendance at sporting or other important events in today's mobile and global society, resulting in more extensive and extended professional travel as well as more fragmented extended family units and communities.

Additionally, missing sporting or other important events of one's family member, friend, relative, or other significant person is a common and unfortunate problem in today' s world of increasing population centers, congested traffic, extended or overlapping sports' seasons, and the like.

Current products may permit one to follow the statistics of one or more players on a team and the current game status.

What is needed is an apparatus, a system, or a method that permits one to remotely attend, monitor, review, and capture events, especially amateur sporting events.

What is also needed is an apparatus, a system, or a method that permits one to remotely monitor and view events, especially amateur sporting events, without the cost of a broadcast team.

### BRIEF SUMMARY

Apparatuses, systems, networks, and methods for permitting remote virtual attendance at remote events, including amateur sporting events, are provided substantially as illustrated by and/or described in connection with at least one of the figures, as set forth more completely in the claims.

In one embodiment, an apparatus for permitting remote virtual attendance at an event is provided that includes a network interface capable of communicating with the Internet, at least one transceiver capable of communicating with the network interface, and multiple cameras capable of communicating with the transceiver. The transceiver is preferably wireless, but may also be wired. The network interface may include, for example, a second transceiver, or a router and modem, or the like. The network interface is capable of communicating over one or more networks including one or more of a private network, a local area network (LAN), a wireless LAN, the Internet, a cloud network, or over a wired or wireless network. The cameras are located in or around a field of play, such as a baseball or softball diamond, a football field, a hockey rink, a basketball court, a soccer field, a lacrosse field, or the like. In some embodiments, the cameras may be located on unmanned aerial vehicles, or drones. In some embodiments, the cameras are attached to motorized devices that can move along cables above the field of play. In some embodiments, the cameras are supported by multiple cables that can be manipulated so that the cameras can be moved in three-dimensions above the field of play. The apparatus can also include an object detection system that is capable of directing the cameras where to point or object. Preferably, the object detection system directs the cameras to point to, and stream or record, the video image of a particular player who has been identified. Preferably, object detection cameras are used. To assist with the tracking and the creation of the video, the individual player identified may have a tracking device temporarily affixed to himself, his jersey, or his equipment. The tracking device may be embodied in a bracelet. Alternatively, the player may be tracked based on lettering visible on a jersey, such as a jersey number. Beacons located in or around the field of play may also be used to help locate the individual to be tracked. The cameras are capable of transmitting real-time video of a tracked object to the transceiver.

The network interface is capable of transmitting video of a tracked object over the Internet for receipt by one or more particular remote devices, such as smart phones, smart TVs, tablets, and the like. In this manner, a remotely-located individual can live-follow the play of a particular player or multiple players, in addition to receiving event highlight video clips or links thereto, during a sporting event. The apparatus may also include a memory, and video from the cameras may be saved in the memory. The video that is saved preferably begins at a time period and ends at a time period after the event. The triggering event can be actions that occur in a sporting event, such as (in a baseball game) a bat contacting a baseball, a third strike, or an out.

Alternatively, some embodiments of the present invention may be formed as a system, network, or method.

### BRIEF DESCRIPTION OF THE DRAWINGS

FIG. 1 shows an embodiment of an apparatus for permitting remote virtual attendance according to the present disclosure.

FIG. 2 shows an alternative embodiment of an apparatus for permitting remote virtual attendance according to the present disclosure.

FIG. 3 shows yet another alternative embodiment of an apparatus for permitting remote virtual attendance according to the present disclosure.

FIG. 4 shows a still further embodiment of an apparatus for permitting remote virtual attendance according to an alternative embodiment of the present disclosure.

FIG. 5 shows another alternative embodiment of an apparatus for permitting remote virtual attendance according to a further alternative embodiment of the present disclosure.

FIG. 6 shows a further embodiment of an apparatus for permitting remote virtual attendance according to yet another alternative embodiment of the present disclosure.

FIG. 7 shows the components of the electronics station for permitting remote virtual access according to one embodiment of the present disclosure.

FIG. 8 shows an alternate embodiment of components of the electronics station for permitting remote virtual access according to another embodiment of the present disclosure.

### DETAILED DESCRIPTION

Some embodiments of apparatuses, systems, and methods for permitting remote virtual attendance at remote events, including amateur sporting events, are provided.

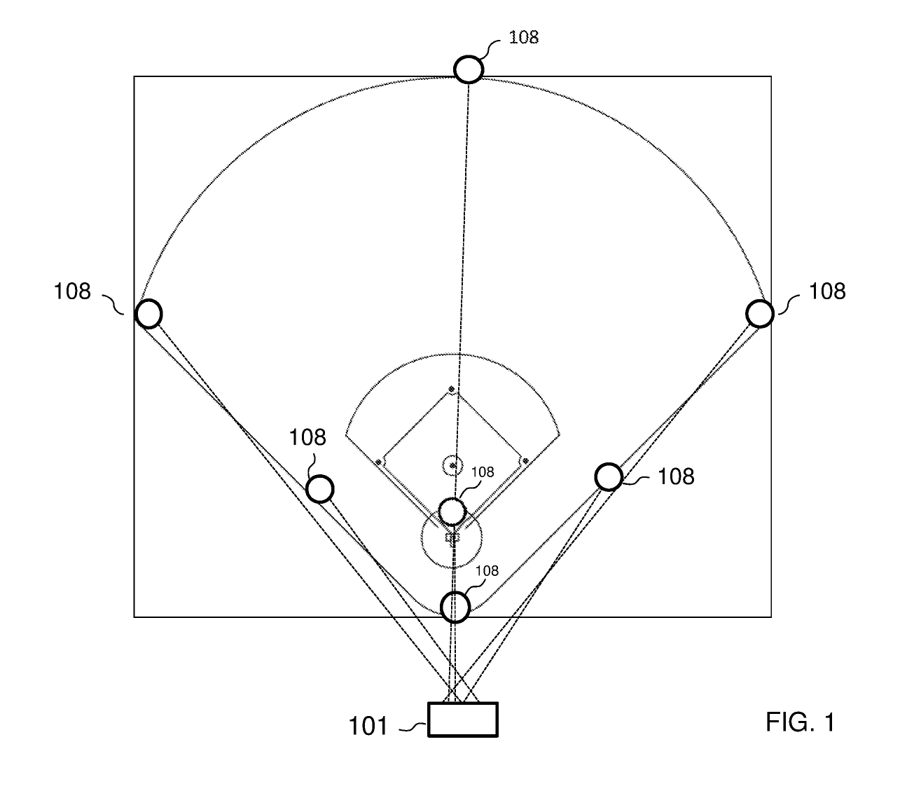

FIG. 1 shows an embodiment of a system 100 for permitting remote virtual attendance at remote events according to one embodiment of the present disclosure. Referring to FIG. 1, the system 100 is set up in connection with, for example, a field of play. In FIG. 1, the field of play is a baseball field, including a baseball diamond. The system 100 includes, for example, a plurality of cameras 108 on, adjacent to, or surrounding the field of play. The cameras may be fixed or portable. In a preferred embodiment, the camera is movable and/or has a zoom function, such that its recognition capability permits it to follow a particular individual, including their movements, and/or an object, such as a ball or puck.

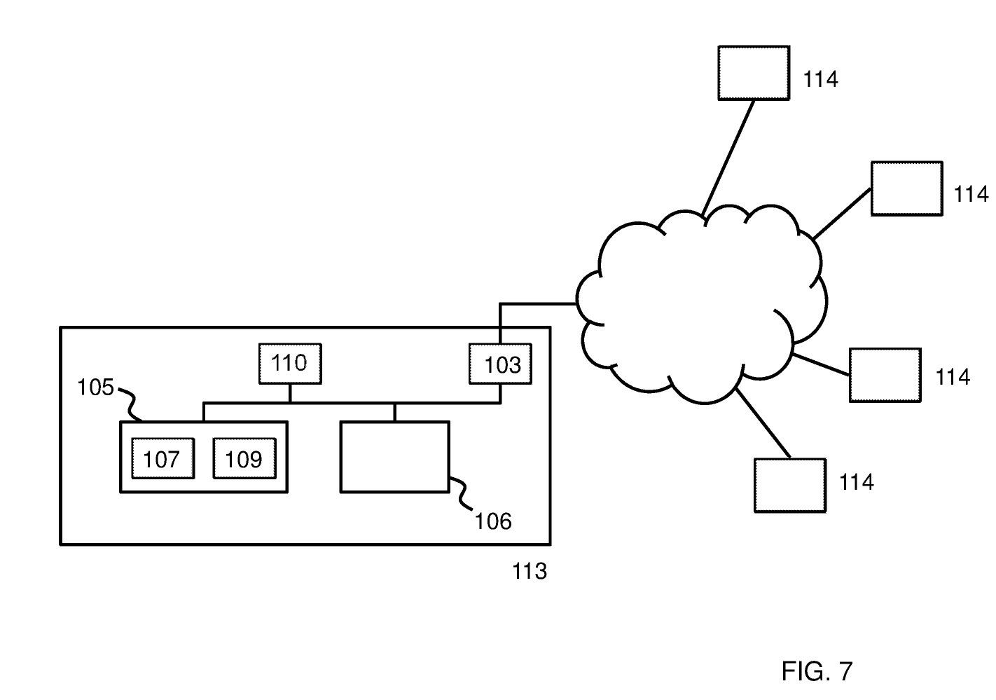

FIG. 7 shows an embodiment of an electronics station 101. Referring to FIG. 7, the electronics station 101 includes, for example, a transceiver 106, a network interface 103, and an object detection or tracking system 110. The transceiver 106, the network interface 103, and the object detection or tracking system 110 can be connected to or be part of a server 105, for example. The server 105 can include, for example, one or more processors 107 and one or more memories or storages 109 (e.g., RAM, ROM, hard drive, optical drive, solid state drive, magnetic drive, electromagnetic drive, storage area network (SAN), virtual memory, hard disk, memory card, etc.). The server 105 can provide the processing power to communicate, via the transceiver 106 or the network interface 103, with the plurality of cameras 108 or with a wired or wireless network that includes the Internet, for example. The server can also use the one or more memories or storages 109 to store the images, series of images, video, data, instructions, commands, code, etc. and as an intermediate memory or storage for calculations, signal processing, data manipulation, intermediate instructions, etc.

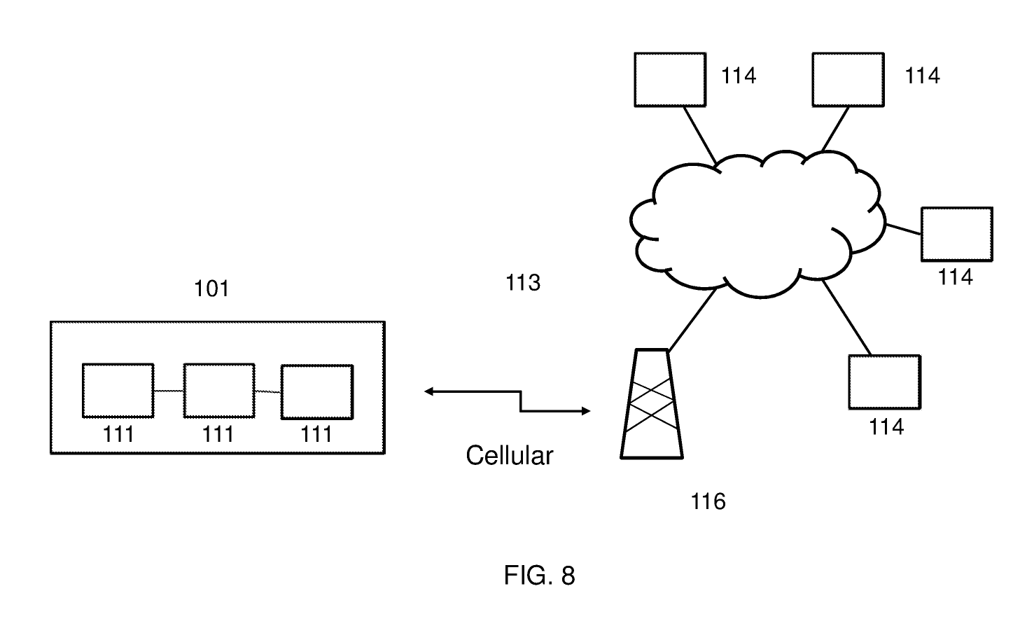

As illustrated in FIG. 8, the system 100 includes an electronics station 101, which includes object detection or tracking system 110, either integrated with, or separate from, the cameras 108. In other words, the cameras 108 preferably have object detection or tracking system 110 capability via an object detection system 110. The object detection or tracking system 110 preferably recognizes an individual, then maintains that individual within the field of view of the camera. In some instances, the object detection or tracking system 110 causes the camera to zoom in or out to change the field of view or to focus on a particular object (e.g., person, ball, etc.) The object detection or tracking system 110 may be based on a recognition capability, such as recognition of jersey number, facial recognition, voice recognition, or some other form of recognition, or an assigned position or a predicted position on the field. The object detection or tracking system 110 may also or alternatively be based on the presence of one or more detectors located on an individual, with optional beacons that permit triangulation to accurately detect the location of the individual in real time. One current, commercially-available solution is the PIXIO Personal Auto-Follow System. The beacons may be capable of actively or passively communicating with a transmitter or detector that is part of the auto-follow system.

In alternate embodiments of the electronics station 101, one or more mobile phones, tablets, or other devices with a camera 108 can communicate with the transceiver by a wireless link such as via WiFi, IEEE 802.11, IEEE 802.16, Zigbee, wireless LAN, WiMax, wireless mesh, Bluetooth, cellular, etc. The camera(s) 108 may be operated manually or automatically (for example, in conjunction with object detection system 110).

FIG. 8 illustrates yet another, alternate embodiment of the electronics station 101. In that embodiment, a mobile phone 111, tablet, or other device is capable of communicating over one or more networks including one or more of a private network, a LAN, a wireless LAN, the Internet, a cloud network, or over a wired or wireless network 113, from which remote users can receive content. Such communication may be done in connection with a cellular network, for example via a ground station 116 (e.g., a base station, a network access point, etc.), or a satellite network that includes satellite stations in the sky or on the ground. In this way, the mobile phone 111, tablet, or other device operates as a network interface.

The object detection system 110 shown in FIG. 8 is shown in communication with the transceiver 106. However, the object detection system 110 may also or alternatively be capable of communicating with the cameras 108. The transceiver 106 is preferably wireless, but may be wired. The transceiver 106 can include, for example one or more antennas for transmitting and receiving signals to one of the cameras 108. Further, the transceiver 106 can include a plurality of transceivers with a plurality of antennas for concurrently, if desired, communicating with the cameras 108.

The system 100 may optionally include microphones and speakers to relay audio, either integrated with the cameras 108 or separate from the cameras 108. The transmission of sound may be either one-way or two-way. If the transmission of sound is two-way, then fans at a remote location may have their encouragement, cheering, or clapping transmitted to a speaker that is at the location of the event.

The system 100 preferably transmits in real-time, and/or records video, and/or audio clips. Such clips may be saved based on predictable sounds or motions, such as the sound of a whistle, the strike or ball call of an umpire, the sound of a batted ball, the sound of a siren for a scored goal, or the like. For example, a camera tracking a player with the puck may save a clip starting with a time period before a goal siren sounds and continuing through a time period after the goal siren sounds. The time period is programmable and may be modified or adapted depending on the event in question, such that different events cause different time periods to be saved. For example, a time period may be selected for a batted ball for someone tracking a batter is preferably long enough to capture the entire pitch, while a time period may be selected for a strikeout for someone tracking a baseball pitcher that is typically long enough to capture the entire pitch sequence. In some embodiments, the cameras transmit video or a series of images to the system 100 which then saves all or some of the video for viewing by a remote user. For example, the system 100 may save and tag activity surrounding or involving a particular player during a game. The particular parameters that determine what is to be clipped or saved can be determined by the system 100 or the remote user.

The system 100 of FIG. 1 also includes at least one network interface 103, and one or more transceivers 106. The network interface 103 may comprise, for example, a second transceiver, or a router and modem, or the like. The network interface is capable of communicating over the Internet, a cloud network, or over a wired or wireless network 113. The network interface is capable of transmitting to, or receiving signals or instructions from, far remote locations using wireless or wired communication protocols or standards such as the Internet (including without limitation TCP/IP, IP, or any modification, adaptation, or equivalents thereof). The transceiver 106 is in communication with a network interface 103 and a plurality of cameras 108.

A series of remote users may access the system 100 using software and a telephone, tablet, or other computer. The preferred method of access is an application (or “app”) running on a smart phone. In a preferred embodiment, the remote users access the system 100 via a subscription-based service for a fee. When the users access the system 100, they may enter or select a preferred individual, player, or position that they wish to monitor. The individual, player, or position may also be pre-identified or pre-selected based on the remote user's preferences. The remote user is then given preference or priority to see the plays or replays (as well as statistics) for that individual, player, or position. Further, since multiple cameras 108 may be directed at a particular player or a particular play, for example, the remote user can view the particular player or the particular play from different angles. In one example, playback can be stopped, and the remote user can view the stopped playback of the particular player or the particular play from multiple angles for that instance of time.

The transceiver 106 is capable of receiving and transmitting electronic signals (e.g., digital information, instructions, commands, data, etc.) to and from the plurality of cameras 108. In some instances, the electronic signals are representative of video clips that may be transmitted via the network interface 103 to remote users. The transceiver 106 is also capable of communicating with near remote locations using communication protocols or standards such as Wi-Fi, IEEE 802.11, or Bluetooth. In this way, not only may remote users watch replays of a play, but fans in the stands may also watch such replays.

In operation, a remote user may be able to watch and/or listen by selecting or defaulting to the preference or priority for a particular individual, player, or position and/or by selecting a particular video camera and/or location to watch. A default camera may be set. The remote user may also be shown recorded clips of their preferred individual, player, or position, for example as an instant replay. When watching in real-time, the remote user may watch an overall field-view (which may be a primary camera, for example, that shows the overall field of view or the area of greatest activity).

Recorded clips may be saved or flagged in a manner that permits the remote user to select them for viewing. For example, a remote user may watch the recorded clips during a down period in a game (such as in between plays or quarters of a football game or during a timeout) or while the preferred individual, player, or position they are watching is not on the field (such as when that player or his or her team is on the bench (e.g., in the bottom of an inning for a home baseball team)). The recorded clips may be selected from a menu or from icons or links on a touch screen.

Recorded clips may also be accessed at a later time, for example by coaches in connection with training, practice, and/or next-level recruiting.

The user may also receive or access peripheral information, such as (by way of example) the overall score, game situation, and notifications when a particular player has entered the game or is up to bat (or about to be up to bat). Other notifications may be received regarding the start of a game or quarter, or when a game is entering overtime.

The various parts of the system 100, including the network interface 103, transceiver 106, cameras 108, and object detection system, are connected to one or more power supplies (e.g., plugged into an AC or DC power supply, drawing power from one or more rechargeable batteries, etc.), which are not shown.

In some embodiments, there are detectors located on individuals, such as wristbands or other wearable devices that can actively or passively communicate with the object detection or tracking device. Wearable devices include, without limitation, integrated circuits or chips. The wearable devices may be worn on the wrist or may be placed, for example, inside a helmet, on a net or goal, on a hat, on a stick, on a glove, or on another suitable piece of clothing or equipment. Other tracking devices can be placed, for example, within the interior or on a surface of a ball or puck.

Detectors may additionally or alternatively be placed on another object, such as, for example, a microphone or wiring or electronics associated therewith. Thus, it is apparent that embodiments of the present invention are not limited to sporting events, but may also be applied to non-sporting events, including without limitation plays, concerts or recitals.

When detectors are located on individuals, the system 100 may become more fully automated. For example, a baseball player who is on offense and is leading off of a particular base between pitches (or taking secondary leads after pitches are thrown), or who stands within a proximity of a particular base for at least a predetermined time may be said to be occupying that base, and may be indicated to be the same within the app.

Moreover, when a tracking device is located in or on a ball (such as a baseball) or other ball tracking software is utilized, the pitch count may be automatically updated (by incrementing the pitch count by one). Additionally, tracking ball speed may permit the speed of a pitch to be recorded and/or transmitted. Also, tracking speed and/or movement of a baseball may permit automatic recording and/or transmission of pitch type. Also, if there are means for detecting a ball and strike (either by a directional or other microphone for an umpire behind home plate or electronically based on the height and location of a pitch), the ball and strike count may be incremented.

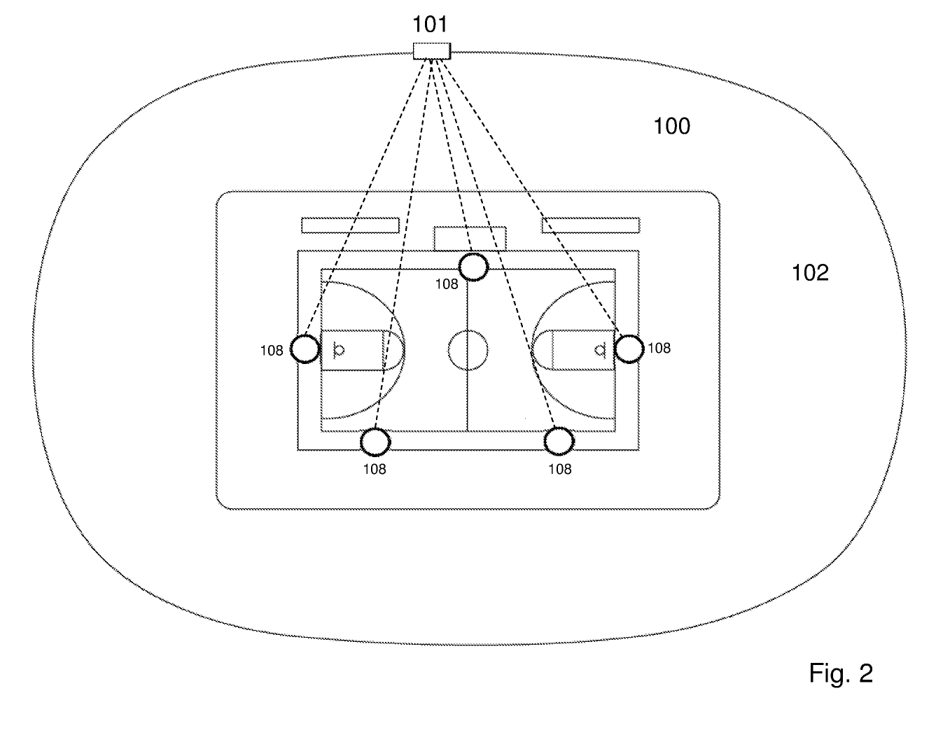

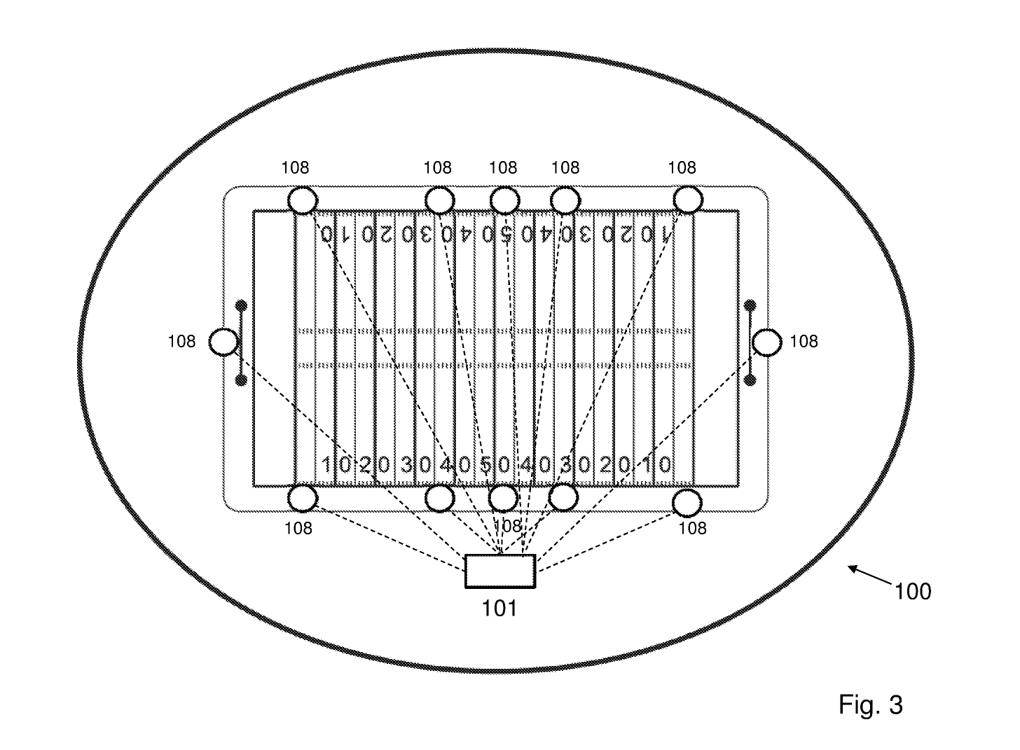

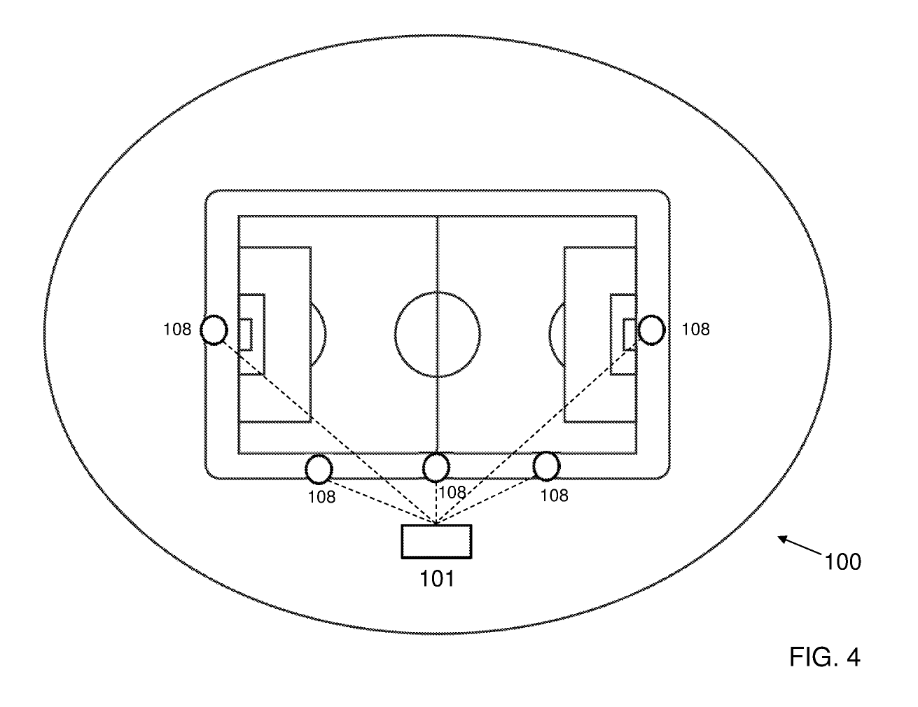

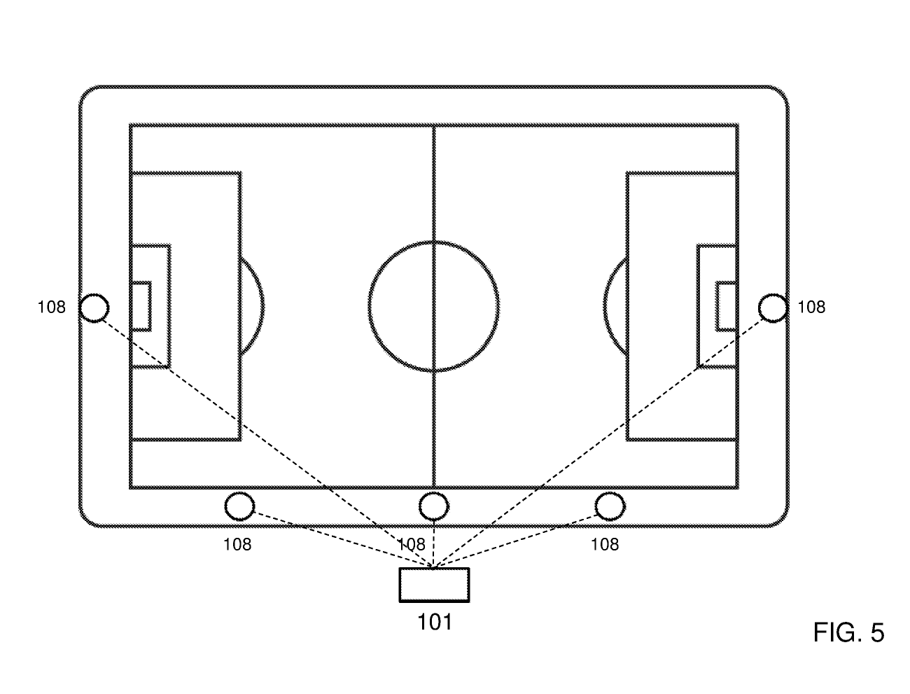

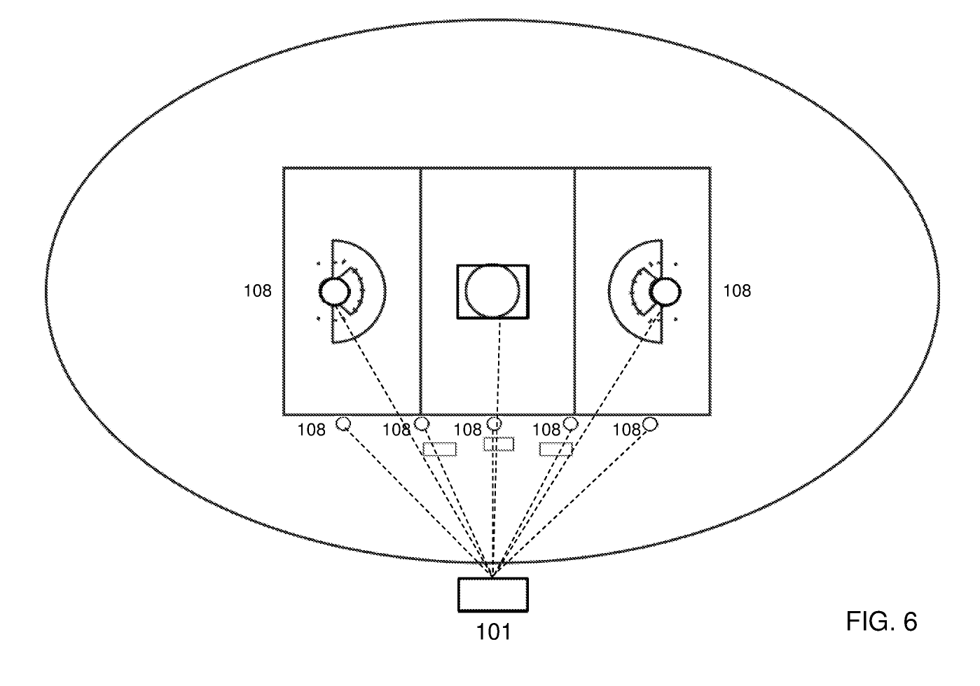

Multiple cameras 108 may be placed on or around the field of play, as demonstrated in FIGS. 1-6. As shown, the system 100 may be used in connection with any one of a different variety of sports or non-sporting events. Sports in connection with which the system 100 may be used are potentially limitless, and include baseball, softball, football, hockey, basketball, soccer (indoor or outdoor), lacrosse, or any other sport in which individuals compete on a field of play. Examples of cameras 108 on the field of play (e.g., “inside” the lines) include a camera embedded in the ground in front of a home plate, as illustrated in FIG. 1.

Alternatively or additionally, one or more cameras 108 may be placed on individual players or other individuals in or around the field of play (such as, for example, coaches, referees, or umpires). Camera time may be shared or prioritized among various users based on, for example, a system of time-division or sharing, the activity level associated with a preferred player or individual, or the subscription level of a remote user. Additionally, multiple cameras 108 may be placed at the same location, so that multiple remote users may watch video from a particular location simultaneously. At the same time, the multiple cameras 108 placed at the same location may be able to focus on different players for the remote users to follow.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the present invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

While the present apparatuses, systems, and/or methods have been described with reference to certain implementations, it will be understood by those skilled in the art that various changes may be made and equivalents may be substituted without departing from the scope of the present apparatuses, systems, and/or methods. In addition, many modifications may be made to adapt a particular situation or material to the teachings of the present disclosure without departing from its scope. Therefore, it is intended that the present apparatuses, systems, and/or methods not be limited to the particular implementations disclosed, but that the present apparatuses, systems, and/or methods will include all implementations falling within the scope of the appended claims.

What is claimed is:

1. An apparatus for permitting remote virtual attendance at an event, comprising:
a network interface capable of communicating with a network that comprises the Internet;
at least one transceiver capable of communicating with the network interface;
a plurality of cameras capable of communicating with the transceiver, which plurality of cameras are disposed in or around a field of play;
an object detection system capable of directing at least one or more of the plurality of cameras where to point; and
wherein at least one or more of the plurality of cameras are capable of transmitting real-time video of a tracked object to the transceiver; and
wherein the network interface is capable of transmitting video of a tracked object over the Internet for receipt by a particular remote device.

2. The apparatus according to claim 1, wherein the tracked object is a ball.

3. The apparatus according to claim 1, wherein the tracked object is a puck.

4. The apparatus according to claim 1, wherein the tracked object is an individual playing in a sporting event.

5. The apparatus according to claim 4, wherein the individual has a tracking device temporarily affixed to himself, his jersey, or his equipment.

6. The apparatus according to claim 5, wherein the tracking device is embodied in a bracelet.

7. The apparatus according to claim 4, wherein the individual is tracked based on lettering visible on a jersey.

8. The apparatus according to claim 7, wherein the lettering visible on a jersey is a number.

9. The apparatus according to claim 1, wherein the object detection system comprises a plurality of beacons to assist in locating an object.

10. The apparatus according to claim 9, wherein the plurality of beacons are disposed in or around the field of play.

11. The apparatus according to claim 1,
further comprising a memory; and
wherein video from at least one or more of the plurality of cameras is saved in a memory based on the occurrence of an event.

12. The apparatus according to claim 11, wherein the video that is saved begins at a time period and ends at a time period after the event.

13. The apparatus according to claim 12, wherein the event is a bat contacting a baseball.

14. The apparatus according to claim 12, wherein the event is a third strike.

15. The apparatus according to claim 12, wherein the event is an out.

16. The apparatus according to claim 1, wherein at least one or more of the plurality of cameras are disposed on unmanned aerial vehicles.

17. The apparatus according to claim 1, wherein the transceiver and network interface are disposed on one or more devices with cellular communication capability.

18. The apparatus according to claim 17, wherein the transceiver and network interface are disposed on one or more cellular phones.

19. The apparatus according to claim 18, wherein at least one or more of the plurality of cameras are disposed on one or more cellular phones.

20. A network for permitting remote observation of an event, comprising:
a network interface capable of communicating with a network that comprises the Internet;
at least one transceiver capable of communicating with the network interface;
a plurality of cameras capable of communicating with the transceiver, which plurality of cameras are disposed in or around a field of play;
an object detection system capable of directing at least one or more of the plurality of cameras where to point; and
wherein at least one or more of the plurality of cameras are capable of transmitting real-time video of a tracked object to the transceiver; and
wherein the network interface is capable of transmitting video of a tracked object over the Internet for receipt by a particular remote device.

21. The network according to claim 20, wherein the tracked object is an individual playing in a sporting event.

22. The network according to claim 21, wherein the individual has a tracking device temporarily affixed to himself, his jersey, or his equipment.

23. The network according to claim 22, wherein the tracking device is embodied in a bracelet.

24. The network according to claim 23, wherein the individual is tracked based on lettering visible on a jersey.

25. The network according to claim 24, wherein the lettering visible on a jersey is a number.

26. The network according to claim 20, wherein the object detection system comprises a plurality of beacons to assist in locating an object.

27. The network according to claim 26, wherein the plurality of beacons are disposed in or around the field of play.

28. The network according to claim 20, further comprising a memory; and
wherein video from at least one or more of the plurality of cameras is saved in a memory based on the occurrence of an event.

29. The network according to claim 28, wherein the video that is saved begins at a time period and ends at a time period after the event.

30. The network according to claim 29, wherein the event is a bat contacting a baseball.

31. The network according to claim 29, wherein the event is a third strike.

32. The network according to claim 29, wherein the event is an out.

33. The network according to claim 20, wherein at least one or more of the plurality of cameras are disposed on unmanned aerial vehicles.

34. The apparatus according to claim 20, wherein the transceiver and network interface are disposed on one or more devices with cellular communication capability.

35. The apparatus according to claim 20, wherein the transceiver and network interface are disposed on one or more cellular phones.

36. The apparatus according to claim 21, wherein at least one or more of the plurality of cameras are disposed on one or more cellular phones.

37. A system for permitting remote observation of an event, comprising:
a network interface capable of communicating with a network that comprises the Internet;
at least one transceiver capable of communicating with the network interface;
a plurality of cameras capable of communicating with the transceiver, which plurality of cameras are disposed in or around a field of play;
an object detection system capable of directing at least one or more of the plurality of cameras where to point; and
at least one device remote from the field of play;
wherein at least one or more of the plurality of cameras are capable of transmitting real-time video of a tracked object to the transceiver; and
wherein the network interface is capable of transmitting video of a tracked object over the Internet for receipt by the at least one remote device.

38. A method for permitting remote observation of an event, comprising:
providing a network interface capable of communicating with a network that comprises the Internet;
providing at least one transceiver capable of communicating with the network interface;
providing a plurality of cameras capable of communicating with the transceiver, which plurality of cameras are disposed in or around a field of play;
providing an object detection system capable of directing at least one or more of the plurality of cameras where to point; and
receiving a connection to the network interface from at least one device remote from the field of play;
wherein at least one or more of the plurality of cameras are capable of transmitting real-time video of a tracked object to the transceiver; and
wherein the network interface is capable of transmitting video of a tracked object over the Internet for receipt by the at least one remote device.
